(19) United States
(12) Patent Application Publication
(10) Pub. No.: US 2011/0089598 A1
(43) Pub. Date: Apr. 21, 2011

(54) METHOD FOR MAKING CONTOURED DECORATIVE GRASS

(76) Inventor: Donald E. Weder, Highland, IL (US)

(21) Appl. No.: 12/975,867

(22) Filed: Dec. 22, 2010

Related U.S. Application Data
(63) Continuation of application No. 11/978,324, filed on Oct. 29, 2007, now abandoned.
Application No. 11/978,324 is a continuation of application No. 11/820,645, filed on Jun. 20, 2007, now abandoned.
Application No. 11/820,645 is a continuation-in-part of application No. 10/375,868, filed on Feb. 27, 2003, now abandoned.

(51) Int. Cl. B29C 59/02

(52) U.S. Cl. 264/132

(57) ABSTRACT

Method for producing decorative grass, such as Easter grass, from a material, wherein the strips of decorative grass have a decorative pattern thereon. The decorative pattern may be printed material and/or embossed patterns thereon, or the decorative pattern may be a non-linear side edge that provides the decorative grass with a contoured configuration.

### CROSS REFERENCE TO RELATED APPLICATIONS

This application is a continuation of U.S. Ser. No. 11/978,324, filed Oct. 29, 2007, now abandoned; which is a continuation of U.S. Ser. No. 11/820,645, filed Jun. 20, 2007, now abandoned; which is a continuation-in-part of U.S. Ser. No. 10/375,868, filed Feb. 27, 2003.

The entire contents of each of the above-referenced patents and patent applications are hereby expressly incorporated herein by reference.

### STATEMENT REGARDING FEDERALLY SPONSORED RESEARCH

Not applicable.

### FIELD OF THE INVENTION

The presently disclosed and claimed inventive concept(s) relates generally to decorative grass and methods for making same, and more particularly, but not by way of limitation, to a decorative grass having a decorative pattern thereon and to a method for producing same. In one aspect, the presently disclosed and claimed inventive concept(s) relates to a decorative grass having an embossed and/or printed pattern thereon and to a method for producing same. In yet another aspect, the presently disclosed and claimed inventive concept(s) relates to a decorative grass having at least one substantially non-linear side edge that provides a decorative pattern thereto and to a method for producing same.

### BRIEF DESCRIPTION OF PRIOR ART

Decorative grass has been used for many years in Easter baskets and for other decorative purposes. The decorative grass of the prior art has been produced by numerous methods and from a variety of materials such as polymeric materials, paper or the like. Typically, such materials are cut and shredded to produce segments having predetermined dimensions. One such prior art method for making decorative grass is disclosed in U.S. Pat. No. 4,292,266, issued to Weder et al., wherein a plastic film is extruded and cut into plastic strips which are passed through a slow-speed godet, an oven and a high-speed godet so that the strips are drawn down in width and thickness without breaking. From the high-speed godet, the strips or strands are chopped to a desired length and conveyed to a storage area for subsequent bagging and packaging.

While the prior art methods for making decorative grass have been widely accepted, new and improved methods for making decorative grass having improved aesthetic qualities are being sought which are less costly and wherein the decorative grass has an improved feel. It is to such a decorative grass and method for producing same that the presently disclosed and claimed inventive concept(s) is directed.

### BRIEF DESCRIPTION OF THE DRAWINGS

FIG. 1 is a schematic representation of a system for making a decorative grass having printed material and/or printed designs on at least one side thereof in accordance with the presently disclosed and claimed inventive concept(s).

FIG. 2A is a perspective view of one embodiment of a sheet of printed material for producing decorative grass having printed material on at least one side thereof constructed in accordance with the presently disclosed and claimed inventive concept(s).

FIG. 2B is a perspective view of another embodiment of printed material for producing decorative grass having printed material on at least one side thereof constructed in accordance with the presently disclosed and claimed inventive concept(s).

FIG. 2C is a perspective view of another embodiment of printed material for producing decorative grass having the appearance of a blend of decorative grasses having different colors.

FIG. 3A is a perspective view of a segment of decorative grass constructed from the sheet of printed material of FIG. 2A.

FIG. 3B is a perspective view of a segment of decorative grass constructed from the sheet of printed material of FIG. 2B.

FIG. 3C is a perspective view a plurality of segments of a decorative grass constructed from the sheet of printed material of FIG. 2C wherein the segments of the decorative grass are of a different color to provide the appearance of a blend of decorative grasses.

FIG. 4 is a schematic representation of a system for making a decorative grass having an embossed pattern in accordance with the presently disclosed and claimed inventive concept(s).

FIG. 5 is a perspective view of a decorative grass having an embossed pattern constructed in accordance with the presently disclosed and claimed inventive concept(s).

FIG. 6 is a schematic representation of a system for making a decorative grass having an embossed pattern and printed material thereon in accordance with the presently disclosed and claimed inventive concept(s) wherein the printed material is out of registry with the embossed pattern.

FIG. 7 is a perspective view of a segment of a decorative grass having an embossed pattern and printed material thereon constructed in accordance with the presently disclosed and claimed inventive concept(s) wherein the printed material is out of registry with the embossed pattern.

FIG. 8 is a schematic representation of a system for making a decorative grass having an embossed pattern and printed material thereon in accordance with the presently disclosed and claimed inventive concept(s) wherein the printed material is in registry with the embossed pattern.

FIG. 9 is a perspective view of a segment of a decorative grass having an embossed pattern and printed material thereon constructed in accordance with the presently disclosed and claimed inventive concept(s) wherein the printed material is in registry with the embossed pattern.

FIG. 10 is a perspective view of a segment of contoured decorative grass constructed in accordance with the presently disclosed and claimed inventive concept(s) wherein the segment is provided with two sides that have non-linear edges, thereby providing the segment of contoured decorative grass with a zigzag shape.

FIG. 11 is a perspective view of a segment of contoured decorative grass constructed in accordance with the presently disclosed and claimed inventive concept(s) wherein the segment is provided with two sides that have non-linear edges, thereby providing the segment of contoured decorative grass with a sine wave shape.

FIG. 12 is a perspective view of a segment of contoured decorative grass constructed in accordance with the presently disclosed and claimed inventive concept(s) wherein the segment is provided with one side having a non-linear edge, thereby providing the segment of contoured decorative grass with a fretted shape or configuration.

### DETAILED DESCRIPTION OF THE PRESENTLY DISCLOSED AND CLAIMED INVENTIVE CONCEPT(S)

The presently disclosed and claimed inventive concept(s) relates to a decorative grass having improved aesthetic qualities and to methods for making such decorative grass. In one embodiment, decorative grass is produced by providing a flexible sheet or web of material, printing the sheet of material to provide the printed sheet of material containing printed material and/or printed patterns on at least one side thereof, slitting the printed sheet of material to provide a web of flexible strips wherein at least a major portion of the strips have printed material and/or printed patterns on at least one side thereof, and thereafter chopping the flexible strips into segments having a predetermined length to produce a decorative grass having printed material and/or printed patterns on at least one side thereof.

In another embodiment, decorative grass is produced by providing a flexible sheet or web of material, printing at least one surface of the sheet of material with a plurality of different colored inks, slitting the printed sheet of material to provide a web of flexible strips, and thereafter chopping the flexible strips into segments having a predetermined length to produce decorative grass having a plurality of different colored segments and thereby provide the decorative grass with an appearance of a blend of different colors of decorative grass.

In another embodiment, decorative grass is produced by providing a flexible sheet or web of material, embossing the sheet of material to provide the sheet of material with an embossed pattern, slitting the sheet of material having an embossed pattern to provide a web of flexible strips wherein at least a major portion of the strips have an embossed pattern, and thereafter chopping the flexible strips into segments having a predetermined length to produce a decorative grass having an embossed pattern.

In yet another embodiment, decorative grass is produced by providing a flexible sheet or web of material, embossing the sheet of material to provide an embossed pattern thereon and printing the embossed sheet of material to provide embossed, printed sheet of material, slitting the embossed, printed sheet of material to provide a web of flexible strips wherein at least a major portion of the strips have an embossed pattern and printed material, and thereafter chopping the flexible strips into segments having a predetermined length to produce a decorative grass having an embossed pattern and printed material and/or designs.

In yet another embodiment, contoured decorative grass is produced by providing a substantially planar sheet or web of material and cutting the substantially planar sheet or web of material into strips of decorative grass wherein at least one side along the length of each strip has a contoured or substantially non-linear edge that provides a contoured, decorative pattern to the strip of decorative grass.

In a further embodiment, a decorative grass is produced in a similar manner to any of the methods described herein above, except that rather than providing a sheet that must be cut, slit and/or chopped, the decorative grass is directly formed into individual strips by any methods known in the art. The strips of decorative grass may be printed and/or embossed during or after the strip forming process. In addition, when the strips of decorative grass are provided with a contoured or substantially non-linear edge, such contoured or substantially non-linear edge may be provided during or after the strip forming process.

The presently disclosed and claimed inventive concept(s) is related to a method of providing a decorative grass having improved aesthetic qualities. The presently disclosed and claimed inventive concept(s) is also directed to a method for producing a decorative grass having improved aesthetic qualities and feel which is cost effective.

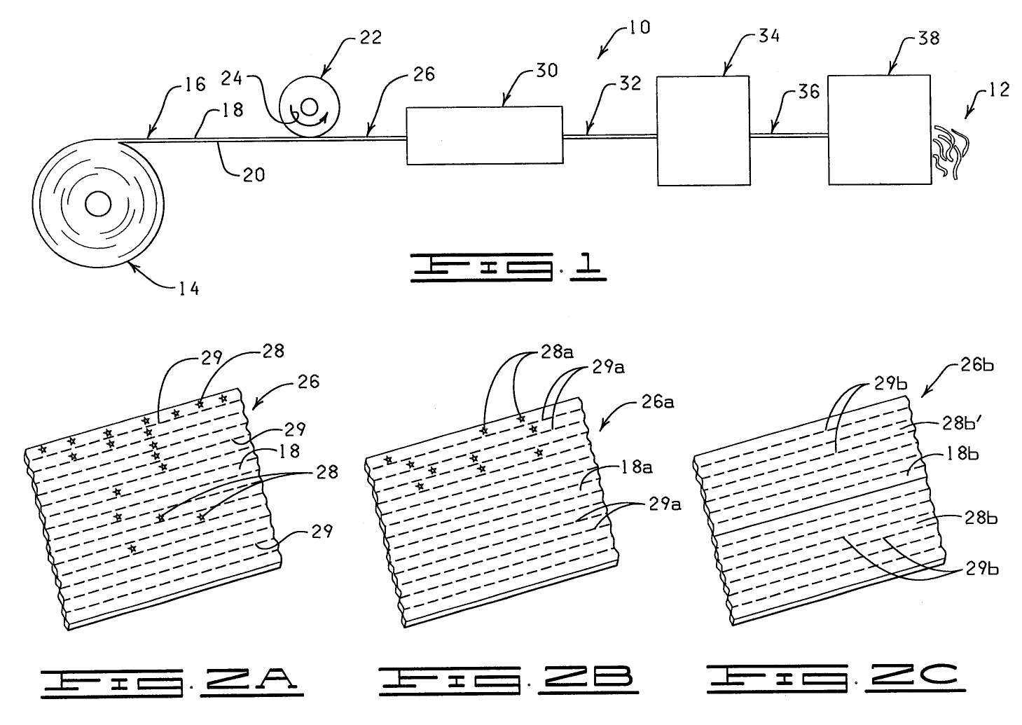

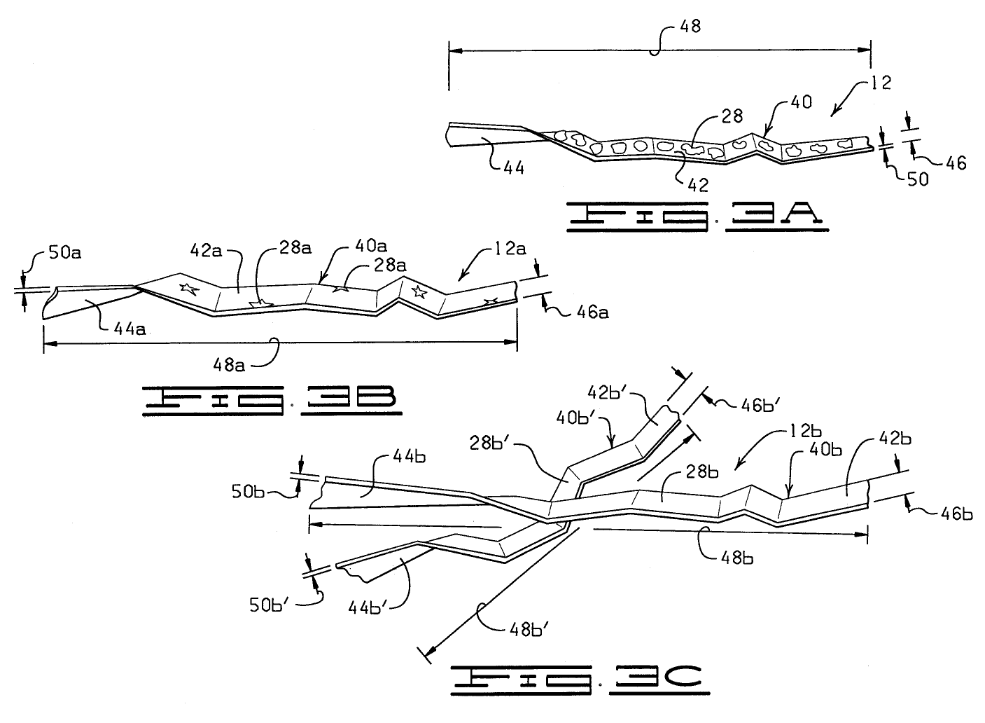

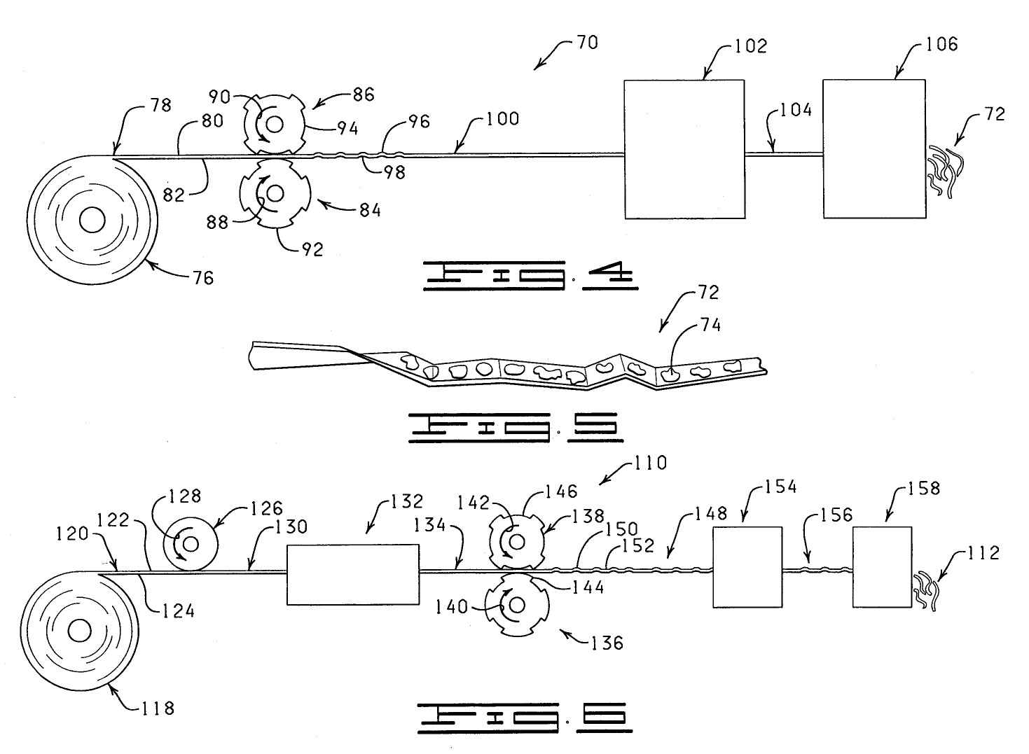

Referring now to the drawings, FIG. 1 illustrates schematically a system 10 for making a decorative grass 12 having printed matter on at least one side thereof in accordance with the presently disclosed and claimed inventive concept(s). A roll of material 14 consisting of a flexible sheet or web of material 16 having a first or upper surface 18 and a second or lower surface 20 is rollingly supported so that, as the sheet of material 16 is passed by an ink roller 22 which is rotated in the direction indicated by the arrow 24, ink is applied to selected portions of the upper surface 18 of the sheet of material 16 to provide a printed sheet of material 26 having a printed design and/or printed material 28 on the upper surface 18 thereof (FIG. 2A), such as a star, a flower design, an animal design and the like, or a special occasion slogan, i.e., happy birthday, an anniversary, Merry Christmas, Happy Mother's Day and the like, or a combination of a printed design and a printed material. The printed design and/or printed material 28 can be selectively printed on the upper surface 18 of the sheet of material 16 by application of ink to the upper surface 18 of the sheet of material 16 (FIG. 2A) so that when the sheet of material 26 is slit (such as along dashed lines 29) and cut into segments to form the decorative grass 12, each segment of the decorative grass 12 contains the printed material and/or printed designs 28 which are confined within the boundaries of the segments of decorative grass 12 substantially as shown in FIG. 3A.

As an alternative, a printed design and/or printed material 28a can be randomly printed on an upper surface 18a of a sheet of material by application of ink to provide a printed sheet of material 26a (FIG. 2B) so that, when the sheet of printed material 26a is slit (such as along dashed lines 29a) and cut into segments to form a decorative grass 12a, each segment of the decorative grass 12a contains at least a portion of the printed design and/or printed material 28a substantially as shown in FIG. 3B.

A printed sheet of material 26b containing a plurality of colors can be produced by the application of various colored inks to an upper surface 18b of a sheet of material, such as a red ink and a green ink indicated by the numerals 28b and 28b′ in FIG. 2C. Thus, when a sheet of printed material 26b is slit (such as along dashed lines 29b) and cut into segments of a decorative grass 12b, a portion of the segments will be red on at least an upper surface thereof and a portion of the segments will be green on at least an upper surface thereof which provides the decorative grass 12b with the appearance of a blended decorative grass containing red colored segments and green colored segments substantially as shown in FIG. 3C.

It should be understood that while the ink roller 22 has been illustrated as being positioned so as to apply ink to the upper surface 18 of the sheet of material 16, the ink roller 22 can be positioned so as to apply ink to the lower surface 20 of the sheet of material 16 or two or more ink rollers 22 can be employed to apply ink to either the upper surface 18 of the sheet of material 16 or to the lower surface 20 of the sheet of material 16, or to apply ink to the upper and lower surfaces 18 and 20 of the sheet of material 16. Further, when employing two or more of the ink rollers 22 to apply ink to the sheet of material 16, different colors of ink can be applied to either the upper surface 18 of the sheet of material 16, or to the lower surface 20 of the sheet of material 16, or to the upper and lower surfaces 18 and 20 of the sheet of material 16.

The sheets or webs of material employed to provide the printed sheets of material 26, 26a and 26b from which the decorative grasses 12, 12a and 12b herein before described are produced are substantially identical in construction, as are the systems for making decorative grasses from such printed sheets of material. Thus, only the sheet or web of material 16 and the system 10 for producing the decorative grass 12 will be described in detail herein after with reference to FIG. 1.

The sheet of material 16 can be constructed of any suitable material capable of having ink affixed thereto so that the printed design and/or printed material 28 can be printed on the sheet of material 16 to produce the sheet of printed material 26. Illustrative of materials which can be employed as the sheet of material 16 are polymeric film, paper, foil, iridescent materials, optical effect materials, and combinations thereof, and laminations thereof.

When the sheet of material 16 is a laminated material and only one surface of the sheet of material 16 is to be printed to produce the sheet of printed material 26, only the side being printed with the printed design and/or printed material must be capable of having the ink affixed thereto.

When the sheet of material 16 is a polymeric film, a flexible sheet of liquified thermoplastic film can be extruded from an extruder in a conventional and well known manner. The flexible sheet of liquified thermoplastic film can then be passed through a cooler which cools the liquified thermoplastic film into a sheet of solidified thermoplastic film, i.e., the sheet of material 16. The sheet of solidified thermoplastic film is then printed in the manner herein before discussed to provide the printed sheet of material 26.

The printed sheet of material 26 is then passed through a drier 30 to produce a dried printed sheet of material 32. The dried printed sheet of material 32 is then passed through a slitter 34, which slits or cuts the dried printed sheet of material 32 into strips or strands of desired width to produce a slitted web 36. The slitted web 36 is then passed into a chopper unit 38 where the slitted web 36 is chopped into segments to produce the decorative grass 12 (FIGS. 1 and 3A) having a predetermined length and which has the desired printed material 28 thereon

When employing a sheet of solidified thermoplastic film to produce the printed sheet of material 26, and depending on the ink pattern applied to the sheet of material 16, it may be desirable after passing the printed sheet of material 26 through the slitter 34, and prior to passage of the slitted web 36 into the chopper unit 38, to heat the slitted web 36 in order to soften the strips or strands of the slitted web 36 so that the strips or strands of the slitted web 36 can be drawn down to provide the strips or strands of the slitted web 36 with a desired width and thickness as described in U.S. Pat. No. 4,292,266 which is herein specifically incorporated by reference.

The decorative grasses 12 produced by passing the slitted web 36 through the chopper unit 38 can then be conveyed to a storage area (not shown) which may be in the form of a suitable bin, conveyed to a packaging machine or to a baling machine for baling prior to storage. As other alternatives, the decorative grasses 12 may be placed into boxes or cartons, subjected to further processing immediately or held for subsequent processing.

The steps of the process shown in FIG. 1 are not specifically limited to the order in which they are shown in FIG. 1 and described herein. For example, it may be desirable to pass the sheet of material 18 through the slitter 34 prior to applying the print to the sheet of material 18 (i.e., using the ink roller 22 and the drier 30). Alternatively, it may be desirable to pass the sheet of material 18 through both the slitter 34 and the chopper unit 38 prior to applying the print thereto. Therefore, any combination of the process steps shown in FIG. 1 falls within the scope of the presently disclosed and claimed inventive concept(s).

In addition, one or more of the cutting and slitting steps of the process of FIG. 1 may be omitted in accordance with the presently disclosed and claimed inventive concept(s). For example, the sheet of material 18 may be provided with a desired length, such that the sheet is simply slit to provide the strips of decorative grass 12. In another embodiment, the decorative grass may be formed by methods other than cutting/slitting. For example, the thermoplastic material may be formed directly into the strips of decorative grass 12 by any method known in the art, such as but not by way of limitation, extrusion molding, thermoforming, injection molding, blow molding, rotational molding, and the like. In such a process, the decorative grass is directly formed from a polymeric material, and therefore no slitting, cutting or chopping steps are required. In this instance, the print may be applied to the strips of decorative grass during the process of forming the strips of decorative grass, or the print may be applied to the strips after the strips have been formed.

Referring now to FIG. 3A, a segment 40 of the decorative grass 12 is illustrated. The segment 40 of the decorative grass 12 is provided with an upper surface 42 having the printed design and/or printed material 28 thereon and a lower surface 44. The segment 40 has a width 46 and a length 48 which define the boundaries of the segment 40; and the printed design and/or printed material 28 is confined within the boundaries of the segment 40 of the decorative grass 12. The width 46 and length 48 of the segment 40 are determined by the processing conditions of the system 10, i.e., the operational parameters of the slitter 34 and the chopper unit 38, or the molding/thermoforming equipment utilized when the strips are directly formed. The width 46 and length 48, as well as thickness 50 of the segment 40 can vary widely and will generally be dependent on the requirements of individual consumers. For most uses, however, the segment 40 will have a width 46 of from about 0.020 inches to about 0.125 inches, a length 48 of from about 2 inches through 24 inches and a thickness 50 of from about 0.5 mil to about 3 mil.

The segments of the decorative grass 12, such as the segment 40, can be produced clear or in almost any color required and the colors can be transparent or opaque, including but not exclusively red, green, yellow, pink, orchid, and blue.

Referring now to FIG. 3B, another embodiment of a segment 40a of a decorative grass 12a is illustrated. The segment 40a of the decorative grass 12a is provided with an upper surface 42a and a lower surface 44a. The upper surface 42a is provided with randomly positioned printed designs and/or printed materials 28a. The segment 40a has a width 46a and a length 48a which define the boundaries of the segment 40a; and only portions of at least a portion of the printed design and/or printed material 28a are confined within the boundaries of the segment 40a of the decorative grass 12a. The width 46a, length 48a and thickness 50a of the segment 40a are determined by the processing conditions; and can vary widely. For most uses, however, the segment 40a will have a width 46a of from about 0.020 inches to about 0.125 inches, a length 48a of from about 2 inches through 24 inches and a thickness 50a of from about 0.5 mil to about 3 mil.

The segments of the decorative grass 12a, such as the segment 40a, can be produced clear or in almost any color required and the colors can be transparent or opaque including but not exclusively red, green, yellow, pink, orchid and blue.

Referring now to FIG. 3C, a plurality of segments of a decorative grass 12b are illustrated, such as segments 40b and 40b′. The segments 40b and 40b′ are produced in the same manner as the segment 40 of the decorative grass 12 hereinbefore described with reference to FIG. 1, with the exception that, in the production of the printed sheet of material 26b (FIG. 2C), two or more ink rollers are employed which apply different colors of ink on the upper surface and/or lower surfaces 18b and 20b of a sheet or web of material to provide the printed sheet of material 26b illustrated in FIG. 2C. Thus, upon processing the printed sheet of material 26b, colored segments of decorative grass 12b having different colors, such as the segments 40b and 40b′, are produced which cooperate to provided the decorative grass 12b with an appearance simulating blended segments of decorative grass. Thus, in a single production run, a blend-appearing decorative grass 12b having segments of different colors, such as the decorative grass 12b containing different segments 40b and 40b′ can be produced.

While the decorative grass 12c of FIG. 3C has been described as being formed from the printed sheet of material 26b of FIG. 2C, it is to be understood that the decorative grass 12c may be directly formed by methods such as but not limited to extrusion molding. In this instance, different colors of ink are applied directly to the individual strands of decorative grass 12c, either during the extrusion process or following formation of the strips of decorative grass 12c.

The segment 40b has a colored upper surface 42b and a lower surface 44b; and the segment 40b has a width 46b and a length 48b, each of which are determined by the processing conditions employed in the production of the decorative grass 12b. Similarly, the segment 40b′ has a colored upper surface 42b′ and a lower surface 44b′; and the segment 40b′ has a width 46b′ and a length 48b′, each of which are determined by the processing conditions of the system 10, i.e., the operational parameters of the slitter 34 and the chopper unit 38 (or the extrusion conditions or other molding conditions utilized when the decorative grass is directly formed). The colored upper surface 42b of the segment 40b is a different color than the colored upper surface 42b′ of the segment 40b′ so that decorative grass 12b containing a plurality of the segments 42b and 42b′ has the appearance of a blended decorative grass.

The widths 46b and 46b′, the lengths 48b and 48b′ and thicknesses 50b and 50b′, respectively, of the segments 40b and 40b′ can vary widely and will generally be dependent on the requirements of individual consumers. For most uses, however, the segments 40b and 40b′ will have a width 46b and 46b′, respectively, of from about 0.020 inches to about 0.125 inches, a length 48b and 48b′, respectively, of from about 2 inches through 24 inches and a thickness 50b and 50b′, respectively, of from about 0.5 mil to about 3 mil.

The segments 40b and 40b′ of the decorative grass 12b can be produced in almost any color and the colors can be transparent or opaque including but not exclusively red, green, yellow, pink, orchid and blue.

Referring now to FIG. 4, a system 70 for making a decorative grass 72 having an embossed pattern 74 (FIG. 5) in accordance with the presently disclosed and claimed inventive concept(s) is schematically illustrated. A roll of material 76 (which consists of a flexible sheet or web of material 78 having a first or upper surface 80 and a second or lower surface 82) is rollingly supported so that the sheet of material 78 is passed between embossing rollers 84 and 86 which are rotated in the direction indicated by the arrows 88 and 90, respectively. The embossing roller 84 has a plurality of raised portions 92 (only one of the raised portions 92 being designated by the reference numeral in FIG. 4); and the embossing roller 86 has a plurality of depressed portions 94 (only one of the depressed portions 94 being designated by the reference numeral in FIG. 4). The depressed portions 94 are arranged on the embossing roller 86 to correspond and register with the raised portions 92 on the embossing roller 84. Thus, as the sheet of material 78 is passed between the embossing rollers 84 and 86, the raised portions 92 of the embossing roller 84 engage the sheet of material 78 and force the sheet of material 78 into the corresponding depressed portions 94 of the embossing roller 86 thereby forming raised portions 96 and depressed portions 98 in the sheet of material 78 as depicted in FIG. 4. That is, passage of the sheet of material 78 between the embossing rollers 84 and 86 produces an embossed sheet of material 100.

The embossed sheet of material 100 is then passed through a slitter 102, which slits or cuts the embossed sheet of material 100 into strips or strands of desired width to produce a slitted web 104. The slitted web 104 is then passed into a chopper unit 106 where the slitted web 104 is chopped to produce the embossed decorative grass 72 (FIG. 5) having a predetermined length and width which define the boundaries of the segment of embossed decorative grass 72; and the embossed pattern 74 lies within the boundaries of at least a portion of the segments of embossed decorative grass 72.

The embossed decorative grass 72 produced by passing the slitted web 104 through the chopper unit 106 can then be conveyed to a storage area (not shown) which may be in the form of a suitable bin, conveyed to a packaging machine or to a baling machine for baling prior to storage. As other alternatives, the embossed decorative grass 72 may be placed into boxes or cartons, subjected to further processing immediately or held for subsequent processing.

The steps of the process shown in FIG. 4 are not specifically limited to the order in which they are shown in FIG. 4 and described herein. For example, it may be desirable to pass the sheet of material 78 through the slitter 102 prior to applying the embossing to the sheet of material 78 (i.e., using the embossing rollers 84 and 86). Alternatively, it may be desirable to pass the sheet of material 78 through both the slitter 102 and/or the chopper unit 106 prior to applying the embossing thereto. Therefore, any combination of the process steps shown in FIG. 4 falls within the scope of the presently disclosed and claimed inventive concept(s).

In addition, one or more of the cutting and slitting steps of the process of FIG. 4 may be omitted in accordance with the presently disclosed and claimed inventive concept(s). For example, the sheet of material 78 may be provided with a desired length, such that the sheet is simply slit to provide the strips of decorative grass 72. In another embodiment, the decorative grass 72 may be formed by methods other than cutting/slitting. For example, the thermoplastic material may be formed directly into the strips of decorative grass 72 by any method known in the art, such as but not by way of limitation, extrusion molding, thermoforming, injection molding, blow molding, rotational molding, and the like. In such a process, the decorative grass 72 is directly formed from a polymeric material, and therefore no slitting, cutting or chopping steps are required. In this instance, the embossing may be applied to the strips of decorative grass during the process of forming the strips of decorative grass, or the embossing may be applied to the strips after the strips have been formed.

The sheet of material 78 can constructed of any suitable material capable of being embossed. Illustrative of material which can be employed as the sheet of material 78 are polymeric film, paper, foil, iridescent materials, optical effect materials and combinations thereof, such as laminated materials.

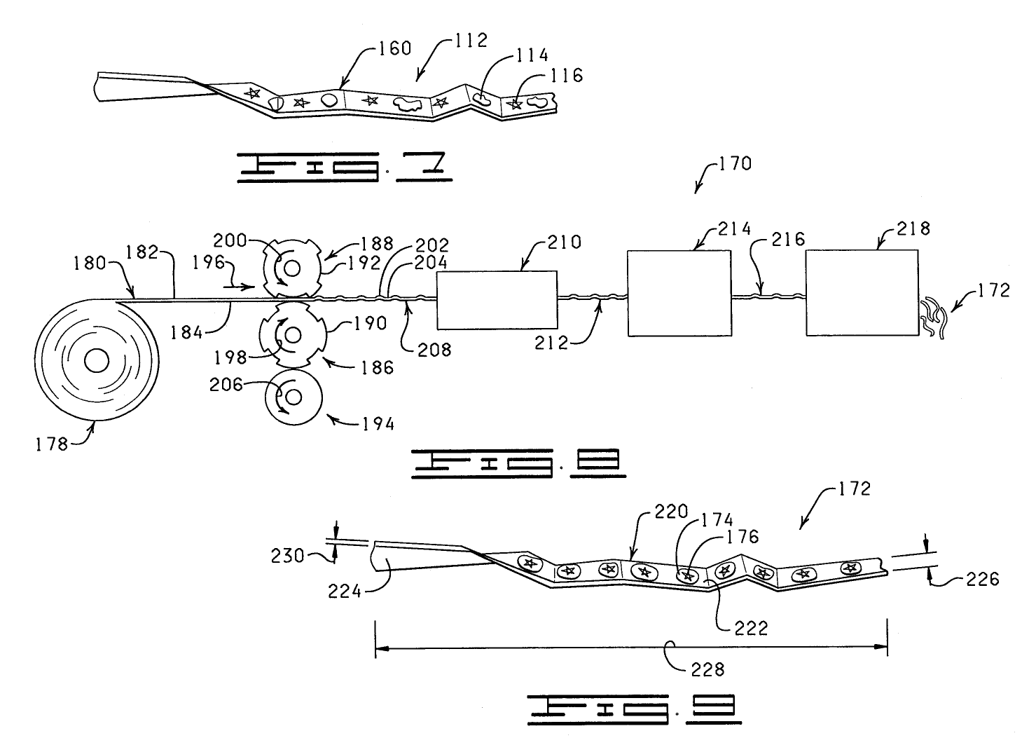

Referring now to FIG. 6, a system 110 for making a decorative grass 112 having an embossed pattern 114 and a printed design and/or printed material 116 (FIG. 7) in accordance with the presently disclosed and claimed inventive concept(s) is schematically illustrated wherein the printed material 116 is out of registry with the embossed pattern 114. A roll of material 118 consisting of a flexible sheet of material 120 having a first or upper surface 122 and a second or lower surface 124 is rollingly supported so that the sheet of material 120 is passed by an ink roller 126 which is rotated in the direction indicated by the arrow 128 so that ink is applied to selected portions of the upper surface 122 of the sheet of material 120 to provide a printed sheet of material 130 having the printed material 116 on the upper surface 122 thereof. The printed material 116 can be a printed design and/or printed material such as a star, a flower, an animal and the like, or a special occasion slogan, i.e., happy birthday, an anniversary, Merry Christmas, Happy Mother's Day and the like, or a combination of a printed design and a special occasion slogan.

It should be understood that while the ink roller 126 has been illustrated as being positioned so as to apply ink to the upper surface 122 of the sheet of material 120, the ink roller 126 can be positioned so as to apply ink to the lower surface 124 of the sheet of material 120 or two or more ink rollers 126 can be employed to apply ink to either the upper surface 122 of the sheet of material 120 or to the lower surface 124 of the sheet of material 120, or to apply ink to the upper and lower surfaces 122 and 124 of the sheet of material 120. Further, when employing two or more of the ink rollers 126 to apply ink to the sheet of material 120, different colors of ink can be applied to either the upper surface 122 of the sheet of material 120, or to the lower surface 124 of the sheet of material 120, or to the upper and lower surfaces 122 and 124 of the sheet of material 120.

The printed sheet of material 130 is then passed through a drier 132 to dry and affix the ink and thereby produce a dried printed sheet of material 134. The dried printed sheet of material 134 is then passed between embossing rollers 136 and 138 which are rotated in the direction indicated by the arrows 140 and 142, respectively. The embossing roller 136 has a plurality of raised portions 144 (only one of the raised portions 144 being designated by the reference numeral in FIG. 6); and the embossing roller 138 has a plurality of depressed portions 146 (only one of the depressed portions 146 being designated by the reference numeral in FIG. 6). The depressed portions 146 are arranged on the embossing roller 138 to correspond and register with the raised portions 144 on the embossing roller 136. Thus, as the dried printed sheet of material 134 is passed between the embossing rollers 136 and 138, the raised portions 144 of the embossing roller 136 engage the dried printed sheet of material 134 and force the dried printed sheet of material 134 into the corresponding depressed portions 146 of the embossing roller 138 thereby forming a sheet of printed and embossed material 148 having raised portions 150 and depressed portions 152.

The printed and embossed sheet of material 148 is then passed through a slitter 154, which slits or cuts the printed and embossed sheet of material 148 into strips or strands of desired width to produce a slitted web 156. The slitted web 156 is then passed into a chopper unit 158 where the slitted web 156 is chopped to produce the decorative grass 112 (FIG. 7) having the embossed pattern 114, the printed material or pattern 116 and a predetermined length and width.

The decorative grass 112 produced by passing the slitted web 156 through the chopper unit 158 can then be conveyed to a storage area (not shown) which may be in the form of a suitable bin, conveyed to a packaging machine or to a baling machine for baling prior to storage. As other alternatives, the decorative grass 112 may be placed into boxes or cartons, subjected to further processing immediately or held for subsequent processing.

The steps of the process shown in FIG. 6 are not specifically limited to the order in which they are shown in FIG. 6 and described herein. For example, it may be desirable to pass the sheet of material 120 through the slitter 154 prior to applying the print and/or embossing to the sheet of material 120 (i.e., using the ink roller 126 and the drier 132, and/or the embossing rollers 136 and 138). Alternatively, it may be desirable to pass the sheet of material 120 through both the slitter 154 and the chopper unit 158 prior to applying the print and/or embossing thereto. In yet another alternative, only one of the print and/or embossing may be applied to the sheet of material 120 prior to passing the sheet of material 120 through the slitter 154 and/or the chopper unit 158. Therefore, any combination of the process steps shown in FIG. 6 falls within the scope of the presently disclosed and claimed inventive concept(s).

In addition, one or more of the cutting and slitting steps of the process of FIG. 6 may be omitted in accordance with the presently disclosed and claimed inventive concept(s). For example, the sheet of material 120 may be provided with a desired length, such that the sheet is simply slit to provide the strips of decorative grass 112. In another embodiment, the decorative grass 112 may be formed by methods other than cutting/slitting. For example, the thermoplastic material may be formed directly into the strips of decorative grass 112 by any method known in the art, such as but not by way of limitation, extrusion molding, thermoforming, injection molding, blow molding, rotational molding, and the like. In such a process, the decorative grass 112 is directly formed from a polymeric material, and therefore no slitting, cutting or chopping steps are required. In this instance, the print and/or embossing may be applied to the strips of decorative grass 112 during the process of forming the strips of decorative grass 112, or the print and/or embossing may be applied to the strips after the strips have been formed.

The sheet of material 120 can be constructed of any suitable material capable of being printed and embossed. Illustrative of material which can be employed as the sheet of material 120 are polymeric film, paper, foil, iridescent materials, optical effect materials and combinations thereof, and laminations thereof.

When the sheet of material 120 is a laminated material and only one surface of the sheet of material 120 is to be printed to produce the sheet of printed material 130, only the side being printed with the printed design and/or printed material must be capable of having the ink affixed thereto.

When the sheet of material 120 is a polymeric film, a flexible sheet of liquified thermoplastic film can be extruded from an extruder in a conventional and well known manner. The flexible sheet of liquified thermoplastic film can then be passed through a cooler which cools the liquified thermoplastic film into a sheet of solidified thermoplastic film, i.e., the sheet of material 120. The sheet of solidified thermoplastic film is then printed and embossed in the manner herein before discussed to provide the printed and embossed sheet of material 148.

FIG. 7 is a perspective view of a segment 160 of the decorative grass 112 having the embossed pattern 114 and printed material 116 thereon constructed in accordance with the presently disclosed and claimed inventive concept(s) wherein the printed material 116 is out of registry with the embossed pattern 114. The term “out of registry” as used herein is to be understood to mean that the embossed pattern or a portion of the embossed pattern is arbitrarily positioned with respect to the printed material on the segments of the decorative grass 112 such as is illustrated in FIG. 7. That is, the embossed pattern 114 produced by embossing the dried printed sheet of material 134 is randomly positioned on the dried printed sheet of material 134 relative to the printed material 116. Thus, when the printed and embossed sheet of material 148 is slit and chopped into segments 160 of the decorative grass 112, the embossed pattern 114 is randomly positioned on the segments 160 of the decorative grass 112 relative to the printed material 116 thereon.

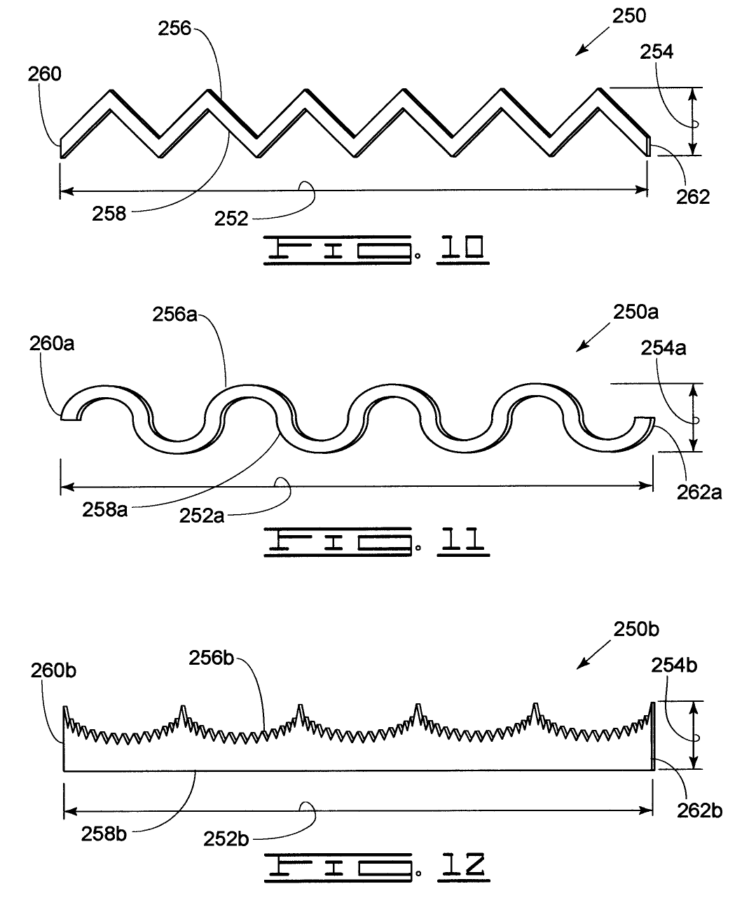

FIG. 8 illustrates schematically another system 170 for producing a decorative grass 172 having an embossed pattern 174 and printed material or pattern 176 (FIG. 9) in accordance with the presently disclosed and claimed inventive concept(s) wherein the printed material 176 is in registry with the embossed pattern 174. A roll of material 178 consisting of a flexible sheet or web of material 180 having a first or upper surface 182 and a second or lower surface 184 is rollingly supported so that the sheet of material 180 is passed between a pair of embossing rollers 186 and 188. The embossing roller 186 has a plurality of raised portions 190 (only one of the raised portions 190 being designated as the reference numeral in FIG. 8). The embossing roller 188 has a plurality of depressed portions 192 (one of the depressed portions 192 being designated as the reference numeral in FIG. 8). The depressed portions 192 are arranged on the embossing roller 188 to correspond and register with the raised portions 190 on the embossing roller 186. An ink roller 194 is disposed near the embossing roller 186 and positioned to apply ink to the raised portions 190 of the embossing roller 186.

The sheet of material 180 is passed between the embossing rollers 186 and 188 in the direction indicated by the arrow 196 and the embossing rollers 186 and 188 are rotated in the direction indicated by the arrows 198 and 200, respectively. As the sheet of material 180 is passed between the embossing rollers 186 and 188, the raised portions 190 on the embossing roller 186 engage the sheet of material 180 and force the sheet of material 180 into the corresponding depressed portion 192 of the embossing roller 188 thereby forming raised portions 202 and depressed portions 204 in the sheet of material 180. The ink roller 194 rotates in a direction indicated by the arrow 206 and applies ink to the raised portions 190 of the embossing roller 186. The raised portions 190 of the embossing roller 186 having the ink thereon transfer the ink to the sheet of material 180 thereby applying a color or printed material to the raised portions 202 of the sheet of material 180 simultaneously with forming the raised portions 202 to provide an embossed, printed sheet of material 208 wherein the embossed pattern 174 and the printed material 176 of the embossed printed sheet of material 208 are in registry.

The term “in registry” as used herein is to be understood to mean that the embossed pattern and the printed material are positioned on the embossed, printed sheet of material in predetermined positions so that the embossed pattern and the printed material are disposed within the confines of a unitary design. For example, FIG. 9 illustrates a unitary pattern or design containing the embossed pattern 174 and the printed material 176 which are within the confines of the unitary pattern or design.

The embossed, printed sheet of material 208 is then passed through a drier 210 to produce a dried embossed printed sheet of material 212. The dried embossed printed sheet of material 212 is then passed through a slitter 214, which slits or cuts the dried embossed printed sheet of material 212 into strips or strands of desired width to produce a slitted web of material 216. The slitted web of material 216 is then passed into a chopper unit 218 where the slitted web 216 is chopped into segments 220 to produce the decorative grass 172 (FIG. 9) having a predetermined length and width and which have the embossed pattern 174 in registry with the printed material 176. It should be noted that by controlling the embossing and printing of the sheet of material 180 to produce the embossed printed sheet of material 208, as well as the slitting of the dried embossed printed sheet of material 212 by passage of same through the slitter 214, the unitary patterns or designs comprising the embossed pattern 174 in register with the printed material 176 can be controlled to lie within the boundaries of the segments 220 constituting the decorative grass 172, or the unitary patterns or designs may be randomly positioned on the sheet of material 180 so that only portions of the unitary patterns or designs lie within the boundaries of the segments constituting the decorative grass 172.

The decorative grass 172 produced by passing the slitted web 216 through the chopper unit 218 can then be conveyed to a storage area (not shown) which may be in the form of a suitable bin, conveyed to a packaging machine or to a baling machine for baling prior to storage. As other alternatives, the decorative grass 172 may be placed into boxes or cartons, subjected to further processing immediately or held for subsequent processing.

The steps of the process shown in FIG. 8 are not specifically limited to the order in which they are shown in FIG. 8 and described herein. For example, it may be desirable to pass the sheet of material 180 through the slitter 214 prior to applying the printing and embossing to the sheet of material 180 (i.e., using the embossing rollers 186 and 188, the ink roller 194 and the drier 210). Alternatively, it may be desirable to pass the sheet of material 180 through both the slitter 214 and the chopper unit 218 prior to applying the printing and embossing thereto. Therefore, any combination of the process steps shown in FIG. 8 falls within the scope of the presently disclosed and claimed inventive concept(s).

In addition, one or more of the cutting and slitting steps of the process of FIG. 8 may be omitted in accordance with the presently disclosed and claimed inventive concept(s). For example, the sheet of material 180 may be provided with a desired length, such that the sheet is simply slit to provide the strips of decorative grass 172. In another embodiment, the decorative grass 172 may be formed by methods other than cutting/slitting. For example, the thermoplastic material may be formed directly into the strips of decorative grass 172 by any method known in the art, such as but not by way of limitation, extrusion molding, thermoforming, injection molding, blow molding, rotational molding, and the like. In such a process, the decorative grass 172 is directly formed from a polymeric material, and therefore no slitting, cutting or chopping steps are required. In this instance, the printing and embossing may be applied to the strips of decorative grass 172 during the process of forming the strips of decorative grass 172, or the printing and embossing may be applied to the strips after the strips have been formed.

The sheet of material 180 can constructed of any suitable material capable of being printed and embossed. Illustrative of material which can be employed as the sheet of material 180 are polymeric film, paper, foil, iridescent materials, optical effect materials and combinations thereof, and laminations thereof.

When the sheet of material 180 is a laminated material and only one surface of the sheet of material 180 is to be printed to produce the embossed printed sheet of material 208, only the side being printed with the printed design and/or printed material 176 must be capable of having the ink affixed thereto.

When the sheet of material 180 is a polymeric film, a flexible sheet of liquified thermoplastic film can be extruded from an extruder in a conventional and well known manner. The flexible sheet of liquified thermoplastic film can then be passed through a cooler which cools the liquified thermoplastic film into a sheet of solidified thermoplastic film, i.e., the sheet of material 180. The sheet of solidified thermoplastic film is then printed and embossed in the manner herein before discussed to provide the embossed printed sheet of material 208.

Referring now to FIG. 9, one segment 220 of the decorative grass 172 is illustrated. The segment 220 of the decorative grass 172 is provided with an upper surface 222 and a lower surface 224. The upper surface 222 is provided with the embossed pattern 174 which is in register with the printed material 176. In addition, the segment 220 has a width 226 and a length 228, each of which are determined by the processing conditions of the system 170, i.e., the operational parameters of the slitter 214 and the chopper unit 218. Further, by controlling the embossing and printing of the sheet of material 180, as well as the slitting of the dried embossed printed sheet of material 212, the segment 220 of the decorative grass 172 is provided with unitary patterns or designs comprising embossed patterns 174 in register with the printed materials 176 which lie within the boundaries of the segment 220.

The width 226, length 228 and thickness 230 of the segment 220 can vary widely and will generally be dependent on the requirements of individual consumers. For most uses, however, the segment 220 will have a width 226 of from about 0.020 inches to about 0.125 inches, a length 228 of from about 2 inches through 24 inches and a thickness 230 of from about 0.5 mil to about 3 mil.

Another embodiment of the presently disclosed and claimed inventive concept(s) is illustrated in FIGS. 10-12. Such embodiment is directed to a contoured decorative grass formed from a substantially planar sheet or web of material similar to the substantially planar sheets or webs of material described herein before. The substantially planar sheet or web of material is cut or otherwise formed into strips or segments of decorative grass in such a manner that provides at least one side extending along a length of each strip or segment with a substantially non-linear edge, thereby providing a decorative pattern to the strips or segments of decorative grass as well as providing such strips with a contoured configuration.

Shown in FIG. 10 is a strip or segment 250 of contoured decorative grass. The strip 250 is provided with a length 252 and a width 254. The strip 250 is further provided with a first side 256 extending along the length 252 of the strip 250, a second side 258 extending along the length 252 of the strip 250, a third side 260 extending along the width 254 of the strip 250, and a fourth side 262 extending along the width 254 of the strip 250. The first and second sides 256 and 258 of the strip 250 are each provided with a contoured, non-linear edge that provides the strip 250 of contoured decorative grass with a zigzag shape or configuration, as opposed to a rectangular or trapezoidal shape as is typically observed for strips of decorative grass.

Shown in FIG. 11 is a strip or segment 250a of contoured decorative grass similar to the strip 250 shown in FIG. 10 and described hereinabove except as described hereinbelow. The strip 250a is provided with a length 252a, a width 254a, a first side 256a, a second side 258a, a third side 260a and a fourth side 262a. The first and second sides 256a and 258a of the strip 250a are each provided with a contoured, non-linear edge that provides the strip 250a of contoured decorative grass with a curved or sine wave shape or configuration.

Shown in FIG. 12 is a strip or segment 250b of contoured decorative grass similar to the strips 250-250a shown in FIGS. 10 and 11 and described hereinabove except as described hereinbelow. The strip 250b is provided with a length 252b, a width 254b, a first side 256b, a second side 258b, a third side 260b and a fourth side 262b. The first side 256b of the strip 250b is provided with a contoured, non-linear edge that provides the strip 250b of contoured decorative grass with a fretted shape or configuration, while the second side 258b of the strip 250b is linear.

While zigzag, sine wave and fretted configurations of contoured decorative grass have been illustrated and described herein, it will be understood that the presently disclosed and claimed inventive concept(s) includes any contoured decorative grass in which at least one side thereof has a non-linear edge that provides the contoured decorative grass with any desired shape or configuration, such as but not limited to, scalloped, heart shaped, clover shaped, egg shaped, and the like. In addition, it is to be understood that strips of contoured decorative grass may be combined with other strips having the same contoured shape, or strips of contoured decorative grass having different contoured shapes may be combined together to provide a mixture of various contours within a grouping of decorative grass.

As described herein above, the substantially planar sheet or web of material from which the contoured decorative grass is constructed may be polymeric film, paper, cloth, foil, iridescent material, optical effect material, or combinations or laminations thereof. The substantially planar sheet or web of material, and therefore the contoured decorative grass formed therefrom, may further be provided with an embossed pattern and/or a printed pattern disposed thereon as described herein above. At least one of the embossed and/or printed patterns may be confined within the boundaries of the strips or segments of contoured decorative grass. In addition, when the contoured decorative grass is provided with embossed and printed patterns, the embossed and printed patterns may be in or out of registry with one another.

Further, the substantially planar sheet of material from which the contoured decorative grass is produced is provided with an upper surface and a lower surface, and the upper surface of the substantially planar sheet of material may be provided with a first printed pattern thereon while the lower surface of the substantially planar sheet of material may be provided with a second printed pattern thereon that is different from the first printed pattern. For example, the first printed pattern may be a solid color, such as but not limited to, blue, and the second printed pattern may be a different solid color, such as but not limited to, red. Upon slitting the substantially planar sheet of material into contoured decorative grass, the first and second printed patterns provide the contoured decorative grass with an appearance of a blend of different colors of grasses.

Alternatively, two separate sheets of material having different printed patterns or colors disposed thereon may be cut in such a manner that provides the strips formed from both sheets of material with the same configuration. The two separate sheets of material may be cut simultaneously, thereby automatically blending the two different types of strips of contoured decorative grass, or the two separate sheets of material may be cut separately and then the two different types of strips of contoured decorative grass mixed and blended together. The result is a blend of contoured decorative grass having different printed patterns or colors wherein each strip has the same or similar contoured configuration.

The contoured decorative grass may be produced using a cutting apparatus as described herein, except that a cutting edge of the cutting apparatus is provided with a pattern or configuration that corresponds to and defines the non-linear edge formed on at least one side, and preferably two sides, of each strip or segment of contoured decorative grass. Desirably, a plurality of knife edges are provided in the cutting apparatus, and when more than one knife edge is present, the knife edges may be the same or different. For example, to provide the strips or segments 250 and 250a of decorative grass shown in FIGS. 10 and 11, the knife edges have the same pattern or configuration, while the strip or segment 250b of decorative grass shown in FIG. 12 is produced by knife edges having different patterns, such as one edge that is linear and provides side 262b with a linear edge and another edge that has the fretted pattern or configuration that provides side 256b with the fretted configuration. When a plurality of knife edges are provided in the cutting apparatus, the plurality of knife edges may be synchronized or may cut independently of one another.

In yet another embodiment, a first substantially planar sheet of material may be passed under a first knife edge having a first configuration and a second substantially planar sheet of material may be passed under a second knife edge having a second configuration different from the first configuration of the first knife edge. Thus, the strips of decorative grass produced from the first and second substantially planar sheets of material are provided with different contoured configurations. The strips of decorative grass produced from the first and second substantially planar sheets of material may then be mixed to provide a blend of contoured decorative grass having different configurations.

In addition, it is to be understood that the decorative grasses 250-250b of FIGS. 10-12 may be formed by methods other than cutting/slitting. For example, the thermoplastic material may be formed directly into the strips of decorative grass by any method known in the art, such as but not by way of limitation, extrusion molding, thermoforming, injection molding, blow molding, rotational molding, and the like. In such a process, the decorative grass is directly formed from a polymeric material, and therefore no slitting, cutting or chopping steps are required. In this instance, the contoured, non-linear edge of each contoured decorative grass is formed during the forming step (i.e., extrusion).

Changes may be made in the construction and the operation of the various components, elements and assemblies described herein and changes may be made in the steps or the sequence of steps of the methods described herein without departing from the spirit and scope of the presently disclosed and claimed inventive concept(s) as defined in the following claims.

What is claimed is:

1. A method for providing a package, comprising the steps of:
providing a container;
producing a plurality of strips of contoured decorative grass formed from a polymeric material, wherein at least one side extending along a length of each strip has a substantially non-linear edge in a flattened configuration, thereby providing a decorative pattern to the strips of contoured decorative grass, wherein the plurality of strips of contoured decorative grass is produced by a molding method;
disposing the plurality of strips of contoured decorative grass in the container;
providing at least one object; and
disposing the at least one object on the plurality of strips of contoured decorative grass in the container.

2. The method of claim 1 wherein, in the step of providing the plurality of strips of contoured decorative grass, the strips of contoured decorative grass have at least one of a zigzag configuration, a scalloped configuration, a sine wave configuration, a fretted configuration, and combinations thereof when in a flattened configuration.

3. The method of claim 1 wherein, in the step of providing a plurality of strips of contoured decorative grass, the strips of contoured decorative grass further comprise at least one of a printed pattern and an embossed pattern on at least a portion thereof.

4. The method of claim 3, wherein the at least one of a printed pattern and an embossed pattern are applied during the step of forming the strips of contoured decorative grass.

5. The method of claim 3, wherein the at least one of a printed pattern and an embossed pattern are applied after the step of forming the strips of contoured decorative grass.

6. The method of claim 3, wherein at least a portion of the strips of contoured decorative grass are provided with a printed pattern and an embossed pattern, and the printed and embossed patterns are in registry with one another.

7. The method of claim 6, wherein each of the strips of contoured decorative grass is provided with a length and width which define boundaries of the strips, and wherein at least one of the printed and embossed patterns is confined within the boundaries of the strips.

8. The method of claim 3, wherein at least a portion of the strips of contoured decorative grass are provided with a printed pattern and an embossed pattern, and the printed and embossed patterns are out of registry with one another.

9. The method of claim 8, wherein each of the strips of contoured decorative grass is provided with a length and width which define boundaries of the segments, and wherein at least one of the printed and embossed patterns is confined within the boundaries of the strips.

10. The method of claim 1, wherein the plurality of strips of contoured decorative grass is produced by a molding method selected from the group consisting of extrusion molding, thermoforming, injection molding, blow molding, rotational molding and casting.

11. A method of producing a contoured decorative grass, comprising the steps of:
providing a polymeric material; and
molding the polymeric material to produce a plurality of strips of contoured decorative grass, wherein at least one side extending along a length of each strip has a substantially non-linear edge in a flattened configuration, thereby providing a decorative pattern to the strips of contoured decorative grass.

12. The method of claim 11, wherein the strips of contoured decorative grass have at least one of a zigzag configuration, a scalloped configuration, a sine wave configuration, a fretted configuration, and combinations thereof when in a flattened configuration.

13. The method of claim 11, wherein the strips of contoured decorative grass further comprise at least one of a printed pattern and an embossed pattern on at least a portion thereof.

14. The method of claim 13, wherein the at least one of a printed pattern and an embossed pattern are applied during the step of forming the strips of contoured decorative grass.

15. The method of claim 13, wherein the at least one of a printed pattern and an embossed pattern are applied after the step of forming the strips of contoured decorative grass.

16. The method of claim 13, wherein at least a portion of the strips of contoured decorative grass are provided with a printed pattern and an embossed pattern, and the printed and embossed patterns are in registry with one another.

17. The method of claim 16, wherein each of the strips of contoured decorative grass is provided with a length and width which define boundaries of the strips, and wherein at least one of the printed and embossed patterns is confined within the boundaries of the strips.

18. The method of claim 13, wherein at least a portion of the strips of contoured decorative grass are provided with a printed pattern and an embossed pattern, and the printed and embossed patterns are out of registry with one another.

19. The method of claim 18, wherein each of the strips of contoured decorative grass is provided with a length and width which define boundaries of the segments, and wherein at least one of the printed and embossed patterns is confined within the boundaries of the strips.

20. The method of claim 11, wherein the plurality of strips of contoured decorative grass is produced by a molding method selected from the group consisting of extrusion molding, thermoforming, injection molding, blow molding, rotational molding and casting.
